(19) United States
(12) Patent Application Publication
(10) Pub. No.: US 2014/0364157 A1
(43) Pub. Date: Dec. 11, 2014

(54) Method And System For Providing A Set Of Target Recipients For A Message

(71) Applicant: Dynmark International Ltd., Cheltenham (GB)

(72) Inventors: David Baddeley, Cheltenham (GB); Paul Putman, Cheltenham (GB)

(21) Appl. No.: 13/910,299

(22) Filed: Jun. 5, 2013

(51) Int. Cl. H04W 4/12

(52) U.S. Cl. CPC H04W 4/12
USPC 455/466

(57) ABSTRACT

A computer-implemented method for providing a set of target recipients for a message, comprising providing data representing an initial set of recipients for the message, filtering the initial set of recipients using a template including at least one filter to provide the target set on the basis of data representing multiple behavioural and factual characteristics associated with the recipients.

### TECHNICAL FIELD

The present invention generally relates to wireless devices and communications networks. In particular the invention relates to processing and interpretation of behavioural, contextual and optionally technical data associated with messaging in wireless devices.

### BACKGROUND

In a telecommunication network or system, messaging service components can be used to allow messages to be exchanged between devices that are part of or otherwise using the network. Such messaging services include for example SMS (short messaging service) and MMS (multimedia messaging service)—the former enabling the transfer of text-based messages between devices, the latter providing a somewhat richer experience inasmuch as messages including multimedia content, such as images, can be exchanged.

Recently, options for message-based communications have further increased with the provision of a number of low-cost and free alternatives to the above-noted services that provide a somewhat richer user experience. The alternatives are typically referred to as over-the-top (OTT) services, as they enable devices to exchange messages without recourse to the traditional methods of delivery associated with standard messaging services—that is, they operate ‘over-the-top’ of the telecommunication network and operate using a provider-independent platform.

Typically, a user of a mobile device, such as a mobile telephone for example, will send and receive multiple messages over the course of a given period of time, such as a day for example, using any one or more of the above-noted methods. Data associated with the messages that are sent and received include useful intelligence.

Consumers are increasingly wary of unsolicited, untargeted messages being sent to their devices using the above mechanisms, such as messages relating to a marketing campaign for example. Typically, a user will either not respond to such a message, or may respond indicating their desire not to receive any further unsolicited messages. Such messages are therefore a waste of resources for an enterprise that is looking to spread a marketing campaign by message, and a more targeted and intelligent proposition would therefore be advantageous for both parties.

### SUMMARY OF THE INVENTION

According to an aspect, there is provided a computer-implemented method for providing a set of target recipients for a message, comprising providing data representing an initial set of recipients for the message, filtering the initial set of recipients using a template including at least one filter to provide the target set on the basis of data representing multiple behavioural and factual characteristics associated with the recipients. A modified message to be sent to the target set of recipients can be provided by processing data representing the message. Recipients in the target set can be respectively identified using a unique identifier. In an example, the identifier is a phone number. A template can be defined or generated using multiple filters. A behavioural characteristic can relate to the propensity of a recipient to act on the message or otherwise follow a link to further information provided in the message. The message can include one or more trackable URLs.

A set of target recipients can form a query result representing a set of phone numbers that meet conditions, constraints or requirements for a message to be sent. Behavioural and factual characteristics can be updated and/or augmented on the basis of receipt of the message. Receipt of the message can be determined using a read receipt to indicate that the message has been opened. Receipt of the message can be determined on the basis that a URL embedded in the message has been accessed by a recipient.

According to an aspect, there is provided a system comprising at least one processor, and a memory operatively connected to the at least one processor, wherein, responsive to execution of computer readable program code accessible to the at least one processor, the at least one processor is configured to receive data representing an initial set of recipients for the message, process the initial set of recipients using a template including at least one filter to provide a target set of recipients on the basis of data representing multiple behavioural and factual characteristics associated with the recipients. The at least one processor can be configured to process data representing the message to provide a modified message to be sent to the target set of recipients. The at least one processor can be configured to identify recipients in the target set using a unique identifier. The at least one processor can be configured to generate a template using multiple filters. The at least one processor can be configured to generate a measure representing a behavioural characteristic representing the propensity of a recipient to act on the message or otherwise follow a link to further information provided in the message. The at least one processor can be configured to determine the presence of a URL in the message, shorten the URL and enable tracking of a response to the URL.

According to an aspect, there is provided a computer program product, comprising a computer usable medium having computer readable program code embodied therein, said computer readable program code adapted to be executed to implement a method for providing a set of target recipients for a message as provided above.

### BRIEF DESCRIPTION OF THE DRAWINGS

Embodiments will now be described, by way of example only, with reference to the accompanying drawings, in which:

FIG. 1 is a schematic block diagram of a system according to an example;

FIG. 2 is a flowchart of an overview of messaging system according to an example;

FIG. 3 is a schematic block diagram of a process to query a system according to an example; and

FIG. 4 is a schematic block diagram of a process to query a system according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

According to an example, data associated with and generated from multiple messages that are sent and received between multiple users, and/or between an enterprise and multiple users for example, can be used to enable the sending of targeted messages to end customers/users using the most appropriate route, whilst learning more about customers' behaviour. In this context, targeted can mean a lower volume of messages that are more focused on the right customers at the right time.

Advanced reporting and analysis can be performed and made available. Areas that can be analysed and reported on include:
Market Sector Analysis
Device Information
Mobile Networks
Click Through Behaviour
Message rate and volumes targeted at the phone number
Message rate and volume sent by the phone number
Messaging and Click Through Activity by the hour of the day
Speed of Response to Messaging and Click Through's
Type of responses grouped by:
   Positive
   Opt Out
   Expletive

Any and all of these areas can be analysed in different combinations to answer a myriad of queries such as:
What days of the week do you get the best response rates?
What market sectors have the best response rates?
What country has the best response rates for betting market sector?
Do you get fewer stops if you message in the afternoon or the evening?
What is the most popular device?
What percentage of phones have web capabilities?

Consumers are increasingly wary of unsolicited, untargeted messages to their mobiles, and targeted campaigns in which recipients are selected according to preselected criteria can be used to provide an increased likelihood of a recipient being receptive to a message rather than simply disregarding it.

This is advantageous for an enterprise since it can result in higher ROI since people will receive more targeted messages (time, content) and be more likely to respond. Additionally, a more targeted approach can lead to greater satisfaction ratings. In an example, information is linked to numbers rather than names or email addresses, and so there are no privacy implications. Note that the term ‘message’ as used herein is an umbrella term for any communication to mobile devices where the identifier or identity is the number, such as SMS, MMS and compatible OTT messaging platforms for example. In an example, activity by any customer is used to build up a phone number intelligence database.

Intelligent Filtering (IF) of data harvested from message data permits users to automatically filter outbound messages prior to sending to meet specific criteria. In an example, criteria can be defined by IF templates which the user may opt to apply to either all their traffic or selectively. The criteria within a template can be assessed against data held against the phone number being sent to, or against an external data provider. Advantageously, only those phone numbers that match selected sending criteria are sent, and typically the cost of filtering out a number is less than sending a message.

Intelligence Query (IQ) permits customers to request and download a summary of intelligence data for a list of phone numbers. In an example, three categories of intelligence can be provided:
1. Marketing—Information describing the behaviour of a phone number, e.g. likelihood to respond positively to a message or clickthrough to a URL;
2. Device—Information describing the physical characteristic of a number's device, e.g. network, operating system, physical location; and
3. Live—latest information on handset status, network and roaming network.

Customers can filter marketing information results by market sector and time range to improve relevancy of the results.

Intelligent Filtering can thus be characterised as a flexible recipient filtering system that can save a message sender money by avoiding the sending of messages to recipients that do not pass filter criteria they specify, whilst simultaneously reducing spam and unwanted messages to end users. The filtering criteria can be provided using data from a database and system according to an example, but can also include the ability to query external parties' data. In an example, filters that can be used to define or otherwise generate templates for filtering before a message is sent are by default restrictive, and therefore to successfully send a message to a phone number the phone number will have had to have passed all filters within the applied filter set or template. All filters will have an option to invert the result therefore allowing more complex scenarios to be described if required. If the system does not hold sufficient phone number intelligence data to assess the filter it is assumed to have passed the filter unless the user indicates otherwise.

According to an example, filters can be provided for free or can be cost based. In either case, they can be behavioural based filters or fact based filters. For example, a fact based filter can relate to the operating system of device associated with a phone number. A behaviour based filter can relate to the propensity for a user to engage with messages sent relating to a particular market sector for example, such as by a measure relating to the time taken to click through via a URL provided as part of a message.

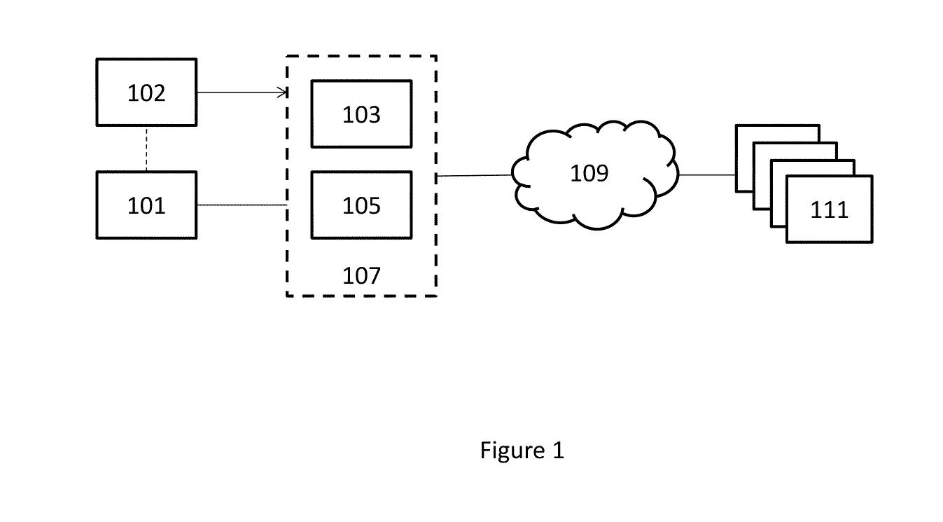

FIG. 1 is a schematic block diagram of a system according to an example. A user equipment device 101 is capable of sending and receiving data representing messages over a network 109. The network 109 is capable of supporting multiple user equipment devices 111, one or more of which can receive a message from device via system 107 and network 109, and which can send a message to device 101 via network 109 and system 107. In an example, network 109 is a telecommunication network or an OTT network, such as a 3G network for example, capable of supporting voice and data transmission between multiple devices. A device 101 can be referred to as a device, terminal, mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various embodiments of the device can include a cellular phone, a smart phone having a wireless communication function, a personal digital assistant (PDA) having a wireless communication function, a wireless modem, a portable computer having a wireless communication function, a capturing device such as a digital camera having wireless communication function, a game device having a wireless communication function, a music storage and replay appliance having a wireless communication function, an Internet appliance enabling wireless Internet access and browsing, and terminals or a portable unit having combinations of the functions. Other alternatives are possible.

In an alternative example, device 101 can send and receive data via the internet if it has the appropriate connection. Similarly, a receiving device can receive message data via a cellular network or over the internet as will be appreciated.

An activity database 103 is provided as part of the system 107 to receive messaging data 102 from user equipment device 101, or from multiple such devices as will typically be the case, over at least one messaging channel of a network. A messaging channel can include a channel for delivery or receipt of an SMS, MMS or OTT message using the network 109, and can also include a channel in which a message is sent or received using an over-the-top (OTT) service over network 109 for example, or alternatively, using a data plan of a device over network 109. For example, an OTT service can be used in which a message is sent or received using TCP/IP with data representing the message being sent over network 109, such as the internet if the device 101 is connected thereto, or being sent using a data plan of the device 101 using network 109.

A profile engine 105 is used to generate a profile for an identity using the messaging data 102. The identity is associated with at least one of the devices. In an example, the identity is linked to a device. However, as users use multiple devices and can migrate a phone number for example from one mobile device to another, the identity is a globally unique identifier that can be, for example, a phone number associated with the device, a device IMEI, or any other such identifier for example. Each identifier, and thus each ultimate device, is typically therefore linked to an ultimate recipient, whatever device they may be using. In an example, as a recipient is identified according to the identifier or identity, the routing of a message is thus largely device independent. That is, a unique identifier can be migrated from device to device, such as when a user ports their number to a new phone for example. Accordingly, in an example, an identifier or identity can be a device independent identifier that more broadly defines a sender or recipient for a message, rather than identifying a specific device for a message. As such references herein to a ‘number’ should be taken to include reference to an identifier, which can include an identifier as described above.

In an example, activity database 103 and profile engine 105 can be implemented in a computer system including a processor, memory, non-volatile storage, and an interface for example. Peripheral devices can also be provided as part of the computer system. A typical computer system will include at least a processor, memory, and a device (e.g., a bus) coupling the memory to the processor. The processor can include, for example, a general-purpose central processing unit (CPU), such as a microprocessor, or a special-purpose processor, such as a microcontroller. The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

A processor is considered to be “configured to execute a program” when at least one value associated with the program is stored in a register readable by the processor. The bus can also couple the processor to one or more interfaces. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

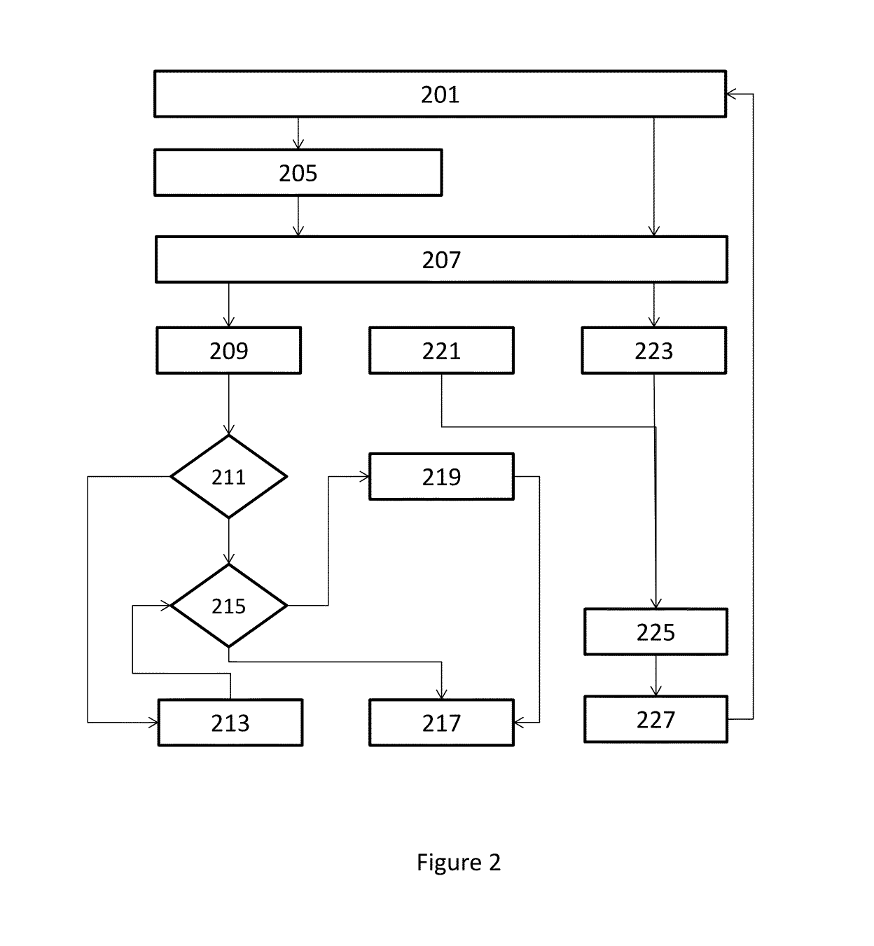

FIG. 2 is a flowchart of an overview of a messaging system according to an example. An external organisation 201 such as an enterprise for example is an entity that wants to send a message to multiple recipients. The message can be a marketing message for example, and can include text content, URLs, multimedia content and the like in any combination. In block 205, enterprise 201 uses an upload portal to provide a message or set of messages and data relating to one or more recipients for a system according to an example. A web-based or standalone application can be used to provide a gateway between enterprise 201 and the system of the present invention, and can include an interface (not shown) to allow an enterprise to easily upload data and make selections relating to desired recipients. Alternatively, enterprise 201 can bypass block 205 and provide data directly to an API 207 that links the enterprise with the system, such that data can be provided ‘as-is’ for example.

In block 209, a message is forwarded for sending. Prior to the message being sent using one of the mechanism described above, in block 211 it is determined if the message should have tracking applied. That is, if the message includes one or more URLs for example, these can be shortened and tracked in block 213. A URL can be shortened by using an HTTP redirect on a domain name that is short, which links to the web page that has a long URL, as is known.

In block 215 it is determined if IF should be applied. If not, the message is forwarded for delivery at block 217 to a delivery service as described above. If, at block 215, IF is to be applied an IF template is applied at block 219. The template can be a filter or multiple filters that are applied to a set of numbers in order to arrive at a target set of recipients from the initial set provided by the enterprise 201. Predefined filters can be provided, as well as predefined sets of filters that go to make up a template. Alternatively, a template tailored to the particular requirements of the enterprise can be generated using multiple filters, each of which can be altered to suit the particular requirement of the enterprise or user. A filter can range from that which selects only numbers that are known to be active, or active or receptive on particular messaging platform from an initial set for example, to filters that can select only number that have a propensity to click-through a URL in a message within a particular market sector in a given timeframe for example.

In an example, a set of numbers can be used to generate a query result that can be returned to the enterprise without a message being sent. That is, recourse can be made at blocks 221 and 223 to query tracking data and intelligence data of a database 225. In block 227 a charge can be made per look up operation for example and the results can be passed back to the enterprise at block 201. In this way, a template can be used, but rather than the filtered numbers being sent a message, they are returned as a query result to the customer.

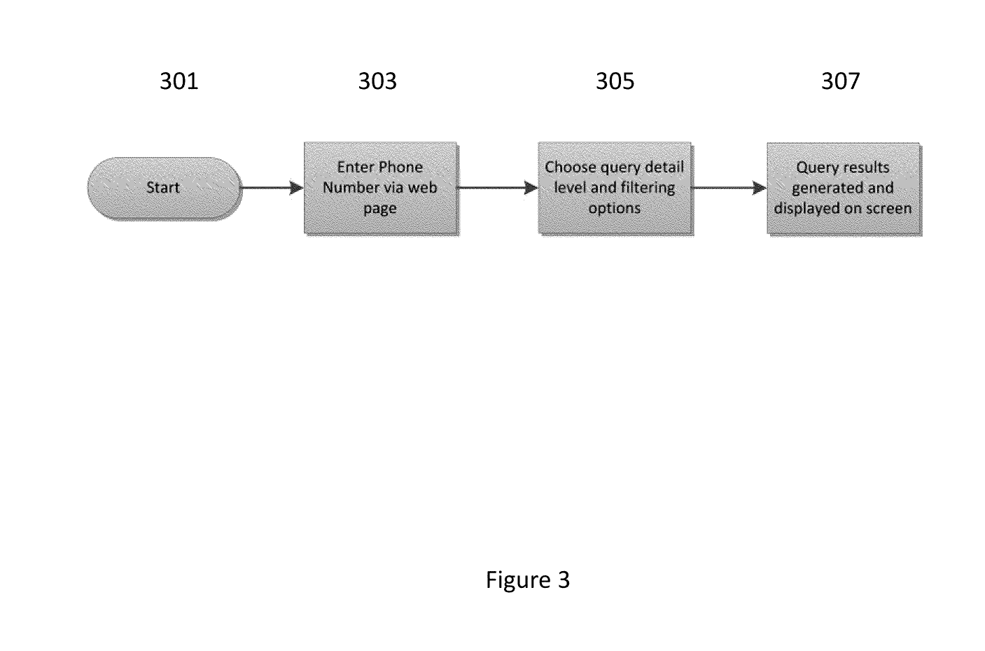

FIG. 3 is a schematic block diagram of a process to query a system according to an example. At block 401 a user, which can be an enterprise as noted above, provides at least one phone number which they enter at block 303 via web page or other suitable application such as a desktop or enterprise application or plug-in as noted above. At block 305, the user is able to select a level of query detail and select filtering options upon which a query will be executed, and at block 407 results are generated and can be displayed to the user for example.

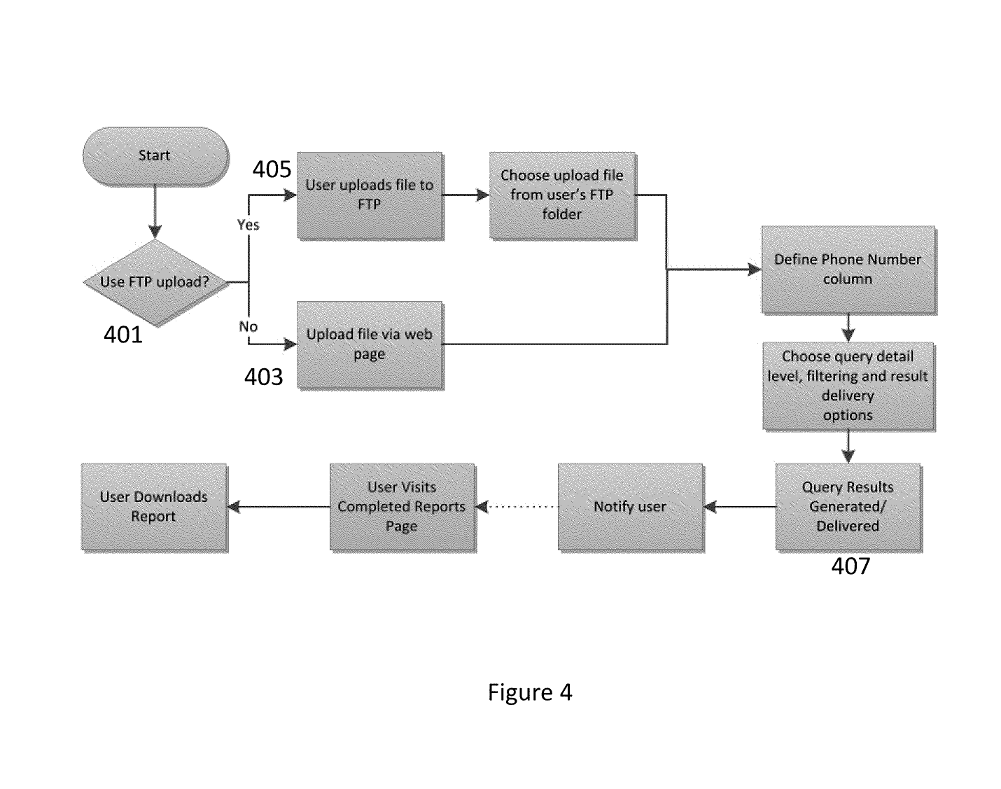

FIG. 4 is a schematic block diagram of a process to query a system according to an example. In the example of FIG. 4 a user is given the option of uploading data to the system via an FTP upload at block 401. If the user does not select or otherwise take this option, data can be provided via a web-based application for example, or using one of the methods noted above. In the alternative, the user uploads data at block 405 and the uploaded data is used to generated query results at block 407 using a query level and filtering options. The results can be stored for a user to pick up at some point in the future for example. Accordingly, the user can be notified that results are waiting, and the user can then visit a reports page of the web application and download or view the report.

Similarly to the above, an automatic generation process can take place in which a user uploads data, which can be automatically detected and processed to generate a report based on a predetermined set of filtering options, which can be user defined or preset for example.

In an example, the system can process ad-hoc and automated queries asynchronously and notify the user via email when a data is ready for download for example. Queries pending or in progress can be cancelled, but can result in a charge for the phone numbers that have been queried up to the point of cancellation. The results for these numbers will be available for download as per a completed query. In an example, a cancelled query cannot be resumed. A query can be resumed if paused.

1. A computer-implemented method for providing a set of target recipients for a message, comprising:
providing data representing an initial set of recipients for the message;
filtering the initial set of recipients using a template including at least one filter to provide the target set on the basis of data representing multiple behavioural and factual characteristics associated with the recipients.

2. A method as claimed in claim 1, further comprising;
processing data representing the message to provide a modified message to be sent to the target set of recipients.

3. A method as claimed in claim 1, wherein recipients in the target set are respectively identified using a unique identifier.

4. A method as claimed in claim 3, wherein the identifier is a phone number.

5. A method as claimed in claim 1, wherein a template is defined or generated using multiple filters.

6. A method as claimed in claim 1, wherein a behavioural characteristic relates to the propensity of a recipient to act on the message or otherwise follow a link to further information provided in the message.

7. A method as claimed in claim 1, wherein the message includes one or more trackable URLs.

8. A method as claimed in claim 1, wherein a set of target recipients forms a query result representing a set of phone numbers that meet conditions, constraints or requirements for a message to be sent.

9. A method as claimed in claim 1, wherein behavioural and factual characteristics are updated and/or augmented on the basis of receipt of the message.

10. A method as claimed in claim 9, wherein receipt of the message is determined using a read receipt to indicate that the message has been opened.

11. A method as claimed in claim 9, wherein receipt of the message is determined on the basis that a URL embedded in the message has been accessed by a recipient.

12. A system comprising:
at least one processor; and
a memory operatively connected to the at least one processor;
wherein, responsive to execution of computer readable program code accessible to the at least one processor, the at least one processor is configured to:
receive data representing an initial set of recipients for the message;
process the initial set of recipients using a template including at least one filter to provide a target set of recipients on the basis of data representing multiple behavioural and factual characteristics associated with the recipients.

13. A system as claimed in claim 12, wherein the at least one processor is configured to process data representing the message to provide a modified message to be sent to the target set of recipients.

14. A system as claimed in claim 12, wherein the at least one processor is configured to identify recipients in the target set using a unique identifier.

15. A system as claimed in claim 12, wherein the at least one processor is configured to generate a template using multiple filters.

16. A system as claimed in claim 12, wherein the at least one processor is configured to generate a measure representing a behavioural characteristic representing the propensity of a recipient to act on the message or otherwise follow a link to further information provided in the message.

17. A system as claimed in claim 12, wherein the at least one processor is configured to determine the presence of a URL in the message, shorten the URL and enable tracking of a response to the URL.

18. A computer program product, comprising a computer usable medium having computer readable program code embodied therein, said computer readable program code adapted to be executed to implement a method for providing a set of target recipients for a message as claimed in claim 1.
